(19) United States
(12) Patent Application Publication
(10) Pub. No.: US 2022/0377068 A1
(43) Pub. Date: Nov. 24, 2022

(54) VEHICLE CONTROL DEVICE, VEHICLE, VEHICLE CONTROL METHOD, AND NON-TRANSITORY RECORDING MEDIUM

(71) Applicant: TOYOTA JIDOSHA KABUSHIKI KAISHA, Toyota-shi (JP)

(72) Inventor: Yusuke YAMAMOTO, Toyota-shi (JP)

(73) Assignee: TOYOTA JIDOSHA KABUSHIKI KAISHA, Toyota-shi (JP)

(21) Appl. No.: 17/657,774

(22) Filed: Apr. 4, 2022

(30) Foreign Application Priority Data
May 19, 2021 (JP) 2021-084862

(51) Int. Cl. H04L 9/40

(52) U.S. Cl. CPC H04L 63/0876; H04L 63/162

(57) ABSTRACT

A processor is electrically connected to a communication section that transmits a control signal upon receiving an operation signal and to a relay section that transmits a control request signal upon receiving the control signal. The processor includes a first processor and a second processor. The first processor is configured to execute an authentication operation to authenticate or not authenticate the relay section, in a case in which the relay section has received the control signal. The second processor is configured to control a control target provided at the vehicle based on the control request signal received from the relay section, in a case in which an authentication-success signal indicating that the relay section is authentic has been received from the first processor.

### CROSS-REFERENCE TO RELATED APPLICATION

This application is based on and claims priority under 35 USC 119 from Japanese Patent Application No. 2021-084862 filed on May 19, 2021, the disclosure of which is incorporated by reference herein.

### BACKGROUND

### Technical Field

The present disclosure relates to a vehicle control device, a vehicle, a vehicle control method, and a non-transitory recording medium.

### Related Art

A vehicle disclosed in Japanese Patent Application Laid-Open (JP-A) No. 2008-078769 includes a communication device capable of wireless communication with external communication equipment, a remote operation reception ECU (relay section) electrically connected to the communication device, and a verification ECU electrically connected to the remote operation reception ECU. On receiving an operation signal emitted by the external communication equipment, the communication device transmits this operation signal to the remote operation reception ECU together with ID information for the external communication equipment. The remote operation reception ECU then transmits the ID information for the external communication equipment to the verification ECU. The verification ECU executes an authentication operation to authenticate or fail the external communication equipment based on the received ID information for the external communication equipment. In cases in which the verification ECU authenticates the external communication equipment, the remote operation reception ECU controls a control target (such as a door locking device) provided to the vehicle based on the received operation signal.

In JP-A No. 2008-078769, the control target is controlled based on the operation signal under the assumption that the remote operation reception ECU is an ECU that can be trusted. There is accordingly room for improvement with respect to checking the trustworthiness of the remote operation reception ECU.

In consideration of the above circumstances, an object of the present disclosure is to obtain a vehicle control device, a vehicle, a vehicle control method, and a non-transitory recording medium that enable a control target to be controlled based on a signal transmitted by a relay section in cases in which a communication section has received an operation signal, while ensuring the trustworthiness of the relay section transmitting the signal.

### SUMMARY

A vehicle control device according to a first aspect of the present disclosure includes a processor installed at a vehicle. The processor is electrically connected to a communication section that transmits a control signal upon receiving an operation signal and to a relay section that transmits a control request signal upon receiving the control signal. The processor includes a first processor and a second processor. The first processor is configured to execute an authentication operation to authenticate or not authenticate the relay section, in a case in which the relay section has received the control signal. The second processor is configured to control a control target provided at the vehicle based on the control request signal received from the relay section, in a case in which an authentication-success signal indicating that the relay section is authentic has been received from the first processor.

In the vehicle control device according to the first aspect of the present disclosure, in a case in which the communication section has received the operation signal, the relay section receives the control signal from the communication section and transmits the control request signal. The first processor executes the authentication operation to authenticate or not authenticate the relay section in a case in which the relay section has received the control signal. The second processor also controls the control target provided at the vehicle based on the control request signal received from the relay section in a case in which the authentication-success signal indicating that the relay section is authentic has been received from the first processor.

In this manner, in the vehicle control device according to the first aspect of the present disclosure, the second processor controls the control target provided at the vehicle based on the control request signal received from the relay section in a case in which the first processor has authenticated the relay section. Thus, the vehicle control device according to the first aspect of the present disclosure enables the control target to be controlled based on the signal received by the second processor in a case in which the communication section has received the operation signal, while ensuring the trustworthiness of the relay section that transmits the signal to the second processor.

A vehicle control device according to a second aspect of the present disclosure depending on the first aspect, wherein the first processor is configured to transmit an authenticity determination signal for determining whether to authenticate or not authenticate the relay section to the relay section in a case in which the first processor has received a first control request signal serving as the control request signal from the relay section; and transmit the authentication-success signal to the second processor, in a case in which the first processor has determined that the relay section is authentic.

In the second aspect of the present disclosure, the first processor transmits the authenticity determination signal for determining whether to authenticate or not authenticate the relay section to the relay section in a case in which the processor has received a first control request signal serving as the control request signal from the relay section. Furthermore, the processor transmits the authentication-success signal to the processor in a case in which the processor has determined that the relay section is authentic. In this manner, in the second aspect of the present disclosure, the first processor receiving the first control request signal from the relay section acts as a trigger for the first processor to execute the authentication operation.

A vehicle control device according to a third aspect of the present disclosure depending on the second aspect, wherein in a case in which the relay section has transmitted a response signal to the first processor in response to the authenticity determination signal, the first processor transmits either the authentication-success signal or an authentication-fail signal indicating that the relay section failed authentication to the second processor based on a type of the received response signal.

In the third aspect of the present disclosure, in a case in which the relay section has transmitted the response signal to the first processor in response to the authenticity determination signal, the first processor transmits the authentication-fail signal or the authentication-success signal to the second processor based on the type of response signal received. The second processor does not control the control target in a case in which the second processor has received the authentication-fail signal. On the other hand, the second processor controls the control target based on the control request signal in a case in which the second processor has received the authentication-success signal. In this manner, in the third aspect of the present disclosure, the first processor determines whether to authenticate or not authenticate the relay section based on the type of signal received, and controls the control target in a case in which the relay section has been authenticated.

A vehicle control device according to a fourth aspect of the present disclosure depending on the third aspect, wherein in a case in which the relay section has received the authenticity determination signal, the relay section transmits the response signal to the first processor and transmits a second control request signal serving as the control request signal to the second processor. The second processor controls the control target, in a case in which the second processor has received the first control request signal, the authentication-success signal, and the second control request signal.

In the fourth aspect of the present disclosure, the second processor controls the control target in a case in which the processor has received the first control request signal, the authentication-success signal, and the second control request signal. Thus, the second processor controls the control target in a case in which the processor has received the second control request signal in addition to the first control request signal. The first control request signal and the second control request signal are signals that are transmitted by the relay section. Thus, the determination regarding the trustworthiness of the relay section is more accurate than if the second processor were to control the control target based only on the first control request signal and the authentication-success signal.

A vehicle control device according to a fifth aspect of the present disclosure depending on the fourth aspect, wherein the second processor controls the control target, in a case in which the second processor has received the authentication-success signal and the second control request signal within a predetermined time limit since the second processor received the first control request signal.

In the fifth aspect of the present disclosure, the second processor controls the control target, in a case in which the processor has received the authentication-success signal and the second control request signal have been received within the predetermined time limit since the processor received the first control request signal. If there were no limit on the duration from the second processor receiving the first control request signal to receiving the authentication-success signal and the second control request signal, there would be an increased risk of a person with malicious intent operating an untrustworthy relay section and thereby causing the relay section to transmit the response signal and the second control request signal so as to cause the first processor to transmit the authentication-success signal. However, in the fifth aspect, the duration from receiving the first control request signal to receiving the authentication-success signal and the second control request signal is limited to the predetermined time limit, and so there is a low risk of such an issue arising.

A vehicle control device according to a sixth aspect of the present disclosure depending on the first aspect, wherein the control target is a power source configured to supply power to a drive source of the vehicle so as to operate the drive source. The second processor switches the power source from one state to another state of a power supply-disabled state or a power supply-enabled state, in a case in which the second processor has received the control request signal.

In the sixth aspect of the present disclosure, upon receiving the control request signal, the second processor switches the power source that supplies power to the vehicle drive source so as to operate the drive source from one state to another state of the power supply-disabled state or the power supply-enabled state. Thus, for example, in a case in which the power source is to be switched from the power supply-disabled state to the power supply-enabled state, power is supplied from the power source to the drive source so as to operate the drive source when the second processor has received the control request signal.

A vehicle according to a seventh aspect of the present disclosure includes the vehicle control device of the first aspect to the sixth aspect, the vehicle control device including the communication section, the relay section, and the processor.

A vehicle according to an eighth aspect of the present disclosure depending on the seventh aspect, wherein the communication section transmits the control signal in a case in which the communication section has received the operation signal from external communication equipment.

A vehicle control method according to a ninth aspect of the present disclosure includes: a communication section installed at a vehicle transmitting a control signal upon receiving an operation signal; a relay section installed to the vehicle transmitting a control request signal upon receiving the control signal from the communication section; and a first processor installed to the vehicle executing an authentication operation to authenticate or not authenticate the relay section in a case in which the relay section has received the control signal, and a second processor installed at the vehicle controlling a control target provided at the vehicle based on the control request signal received from the relay section, in a case in which an authentication-success signal indicating that the relay section is authentic has been received from the first processor.

A non-transitory recording medium according to a tenth aspect of the present disclosure depending on a non-transitory recording medium storing a program executable by a computer to perform processing. The processing includes: a communication section installed at a vehicle transmitting a control signal upon receiving an operation signal; a relay section installed to the vehicle transmitting a control request signal upon receiving the control signal from the communication section; executing an authentication operation to authenticate or not authenticate the relay section in a case in which the relay section has received the control signal; and controlling a control target provided at the vehicle based on the control request signal received from the relay section in a case in which an authentication-success signal indicating that the relay section is authentic has been received.

As described above, the vehicle control device, the vehicle, the vehicle control method, and the non-transitory recording medium according to the present disclosure exhibit advantageous effects of enabling the control target to be controlled based on the signal transmitted by the relay section in a case in which the communication section has received the operation signal, while ensuring the trustworthiness of the relay section transmitting the signal.

### BRIEF DESCRIPTION OF THE DRAWINGS

Exemplary embodiments of the present invention will be described in detail based on the following figures, wherein:

FIG. 1 is a schematic diagram illustrating a vehicle including a vehicle control device according to an exemplary embodiment;

FIG. 2 is a control block diagram of an autonomous driving ECU of the vehicle illustrated in FIG. 1;

FIG. 3 is a functional block diagram of the autonomous driving ECU illustrated in FIG. 2;

FIG. 4 is a functional block diagram of a relay ECU illustrated in FIG. 1;

FIG. 5 is a control block diagram of a verification ECU of the vehicle illustrated in FIG. 1;

FIG. 6 is a functional block diagram of an authentication microcomputer of the verification ECU illustrated in FIG. 5;

FIG. 7 is a functional block diagram of a control microcomputer of a verification ECU;

FIG. 8 is a sequence chart indicating operation executed by the vehicle control device illustrated in FIG. 1;

FIG. 9 is a flowchart illustrating processing performed by the vehicle control device illustrated in FIG. 1; and

FIG. 10 is a flowchart illustrating processing performed by a vehicle control device.

### DETAILED DESCRIPTION

Explanation follows regarding an exemplary embodiment of a vehicle control device 10, a vehicle 12 including the vehicle control device 10, a vehicle control method, and a non-transitory recording medium according to the present disclosure, with reference to the drawings.

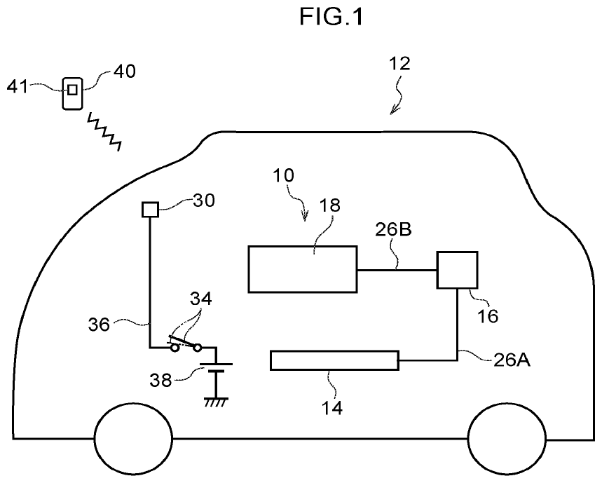

FIG. 1 illustrates the vehicle 12 including the vehicle control device 10 of the present exemplary embodiment. The vehicle control device 10 includes an autonomous driving kit (communication section) 14, a relay electronic control unit (ECU) (relay section) 16, a verification ECU 18, and buses 26A, 26B. The bus 26A electrically connects between the autonomous driving kit 14 and the relay ECU 16. The bus 26B electrically connects between the relay ECU 16 and the verification ECU 18. An in-vehicle network including the autonomous driving kit 14, the relay ECU 16, the verification ECU 18, and the buses 26A, 26B may for example be configured by Ethernet (registered trademark), a controller area network (CAN), or FlexRay (registered trademark). Note that in the present exemplary embodiment, a communication protocol capable of multiplex communication (such as a CAN) is employed for the communication between the autonomous driving kit 14 and the relay ECU 16 through the bus 26A, and the communication between the relay ECU 16 and the verification ECU 18 through the bus 26B.

As illustrated in FIG. 1, an engine ECU 30 for controlling an engine (drive source) (not illustrated in the drawings) is provided to the vehicle 12. An ignition switch (control target) 34 for the engine is electrically connected to the verification ECU 18. The ignition switch 34 is provided on a feed line 36. One end of the feed line 36 is connected to a power source (battery) 38, and the other end of the feed line 36 is connected to the engine ECU 30. The ignition switch 34 is capable of moving between an OFF position illustrated by a solid line, and an ON position illustrated by a two-dot chain line in FIG. 1. An initial position of the ignition switch 34 is the OFF position.

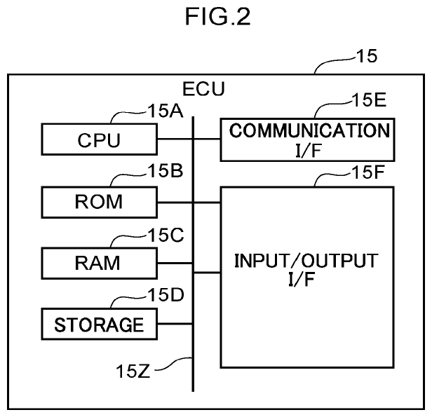

As illustrated in FIG. 1, the autonomous driving kit 14 is provided inside a center console of the vehicle 12. However, the autonomous driving kit 14 may be provided at a different location to the center console of the vehicle 12 (such as a vehicle ceiling section). The autonomous driving kit 14 includes a wireless communication device (not illustrated in the drawings), and an autonomous driving ECU 15, illustrated in FIG. 2. The wireless communication device, the autonomous driving ECU 15, and a sensor group (not illustrated in the drawings) provided to the vehicle 12 are connected to one another. For example, a camera is included in this sensor group. The autonomous driving ECU 15 is configured including a central processing unit (CPU: processor) 15A, read only memory (ROM) 15B serving as a non-transitory recording medium (storage medium), random access memory (RAM) 15C, storage 15D serving as a non-transitory recording medium (storage medium), a communication interface (I/F) 15E, and an input/output I/F 15F. The CPU 15A, the ROM 15B, the RAM 15C, the storage 15D, the communication I/F 15E, and the input/output I/F 15F are connected so as to be capable of communicating with one another through a bus 15Z. The autonomous driving ECU 15 is capable of acquiring timing-related information from a timer (not illustrated in the drawings). Note that although not illustrated in the drawings, hardware configurations of the relay ECU 16 and the engine ECU 30 are the same as that of the autonomous driving ECU 15. In the present exemplary embodiment, the autonomous driving kit 14 is manufactured by a different manufacturer to the manufacturer that manufactured the vehicle 12.

The CPU 15A is a central processing unit that executes various programs and controls various sections. Namely, the CPU 15A reads a program from the ROM 15B or the storage 15D and executes the program using the RAM 15C as a workspace. The CPU 15A controls respective configurations and performs various arithmetic processing according to programs recorded in the ROM 15B. For example, the CPU 15A controls a steering wheel, a brake device, the engine, and indicators in order to execute autonomous driving control (driving support control).

The ROM 15B and the ROM of the relay ECU 16 each hold various programs and various data.

The RAM 15C acts as a workspace to temporarily store programs or data. The storage 15D is configured by a storage device such as a hard disk drive (HDD) or a solid state drive (SSD), and holds various programs and various data. The communication I/F 15E is an interface that enables the autonomous driving ECU 15 to communicate with other equipment. The communication I/F 15E is connected to the bus 26A. The input/output I/F 15F is an interface for communicating with respective devices installed to the vehicle 12.

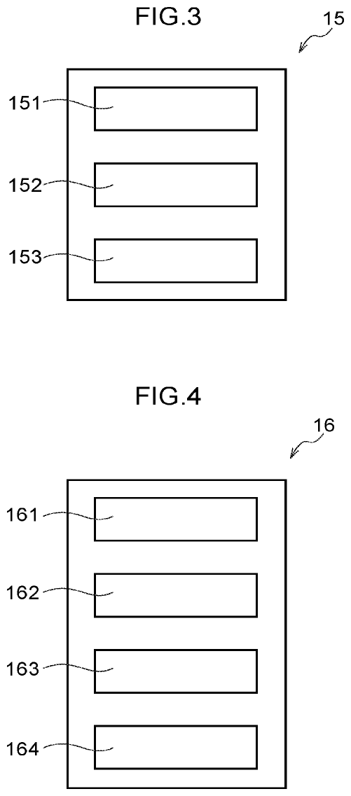

FIG. 3 is a block diagram illustrating an example of functional configuration of the autonomous driving ECU 15. The autonomous driving ECU 15 includes an ID verification section 151, a signal generation section 152, and a transmission section 153 as functional configuration. The ID verification section 151, the signal generation section 152, and the transmission section 153 are realized by the CPU 15A reading and executing a program stored in the ROM 15B.

The ID verification section 151 determines whether or not the wireless communication device has received an operation signal from a mobile terminal (external communication equipment) 40, described later. The ID verification section 151 also determines whether or not ID information for the mobile terminal 40 contained in the operation signal matches ID information contained in an ID information list (not illustrated in the drawings) recorded in the ROM 15B.

The signal generation section 152 generates a control signal for controlling the ignition switch 34 (control target) based on a signal received from the wireless communication device.

The transmission section 153 transmits the control signal generated by the signal generation section 152 to the relay ECU 16 through the bus 26A.

FIG. 4 is a block diagram illustrating an example of functional configuration of the relay ECU 16. The relay ECU 16 includes a reception section 161, a control request signal generation section 162, a response signal generation section 163, and a transmission section 164 as functional configuration. The reception section 161, the control request signal generation section 162, the response signal generation section 163, and the transmission section 164 are realized by the CPU of the relay ECU 16 reading and executing a program stored in the ROM.

The reception section 161 receives the control signal transmitted by the autonomous driving ECU 15, and also receives an authenticity determination signal, described later.

When the reception section 161 has received the control signal, the control request signal generation section 162 generates a first control request signal. Furthermore, when the reception section 161 has received the authenticity determination signal, the control request signal generation section 162 generates a second control request signal.

When the reception section 161 has received the authenticity determination signal, the response signal generation section 163 generates a response signal to the authenticity determination signal. As described later, the authenticity determination signal of the present exemplary embodiment is a signal expressing code encrypted using the advanced encryption standard (AES). Thus, the response signal of the present exemplary embodiment is a signal expressing decrypted data that was encrypted using AES.

The transmission section 164 transmits the first control request signal, and the second control request signal and response signal, that have been generated to the verification ECU 18 through the bus 26B. The transmission section 164 incorporates the second control request signal and the response signal into a single message and transmits this to the verification ECU 18.

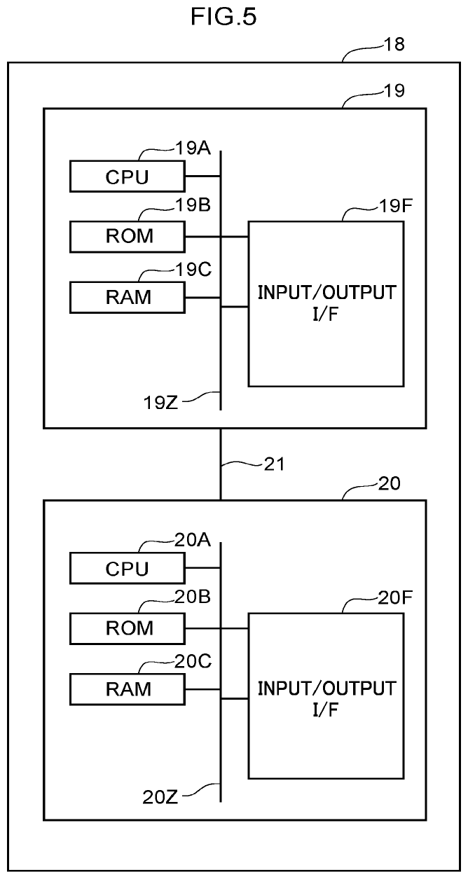

As illustrated in FIG. 5, the verification ECU 18 includes an authentication microcomputer 19 and a control microcomputer (control section) 20. The verification ECU 18 also includes a bus 21 connecting between the authentication microcomputer 19 and the control microcomputer 20. The verification ECU 18 also includes a communication I/F (not illustrated in the drawings).

The authentication microcomputer 19 is configured including a CPU 19A (first processor), ROM 19B serving as a non-transitory recording medium (storage medium), RAM 19C, and an input/output I/F 19F. The CPU 19A, the ROM 19B, the RAM 19C, and the input/output I/F 19F are connected so as to be capable of communicating with one another through a bus 19Z. The authentication microcomputer 19 is capable of acquiring timing-related information from a timer (not illustrated in the drawings).

The control microcomputer 20 is configured including a CPU 20A (second processor), ROM 20B serving as a non-transitory recording medium (storage medium), RAM 20C, and an input/output I/F 20F. The CPU 20A, the ROM 20B, the RAM 20C, and the input/output I/F 20F are connected so as to be capable of communicating with one another through a bus 20Z. The control microcomputer 20 is capable of acquiring timing-related information from a timer (not illustrated in the drawings).

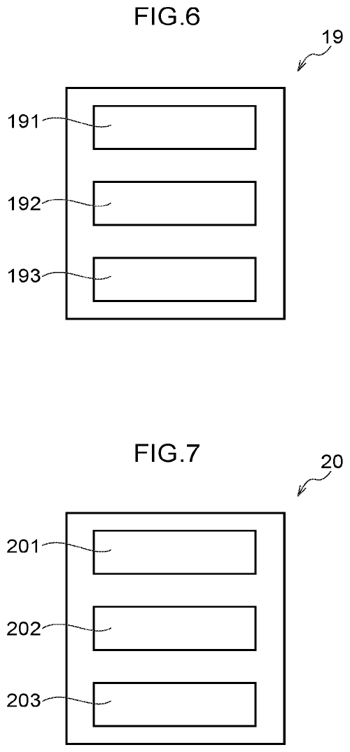

FIG. 6 is a block diagram illustrating an example of functional configuration of the authentication microcomputer 19. The authentication microcomputer 19 includes a reception section 191, a signal generation section 192, and a transmission section 193 as functional configuration. The reception section 191, the signal generation section 192, and the transmission section 193 are realized by the CPU 19A of the authentication microcomputer 19 reading and executing a program stored in the ROM 19B.

The reception section 191 receives the first control request signal and the response signal transmitted by the transmission section 164.

The signal generation section 192 generates the authenticity determination signal. As described above, the authenticity determination signal is a signal expressing code encrypted using AES. The signal generation section 192 also generates either an authentication-success signal or an authentication-fail signal when the reception section 191 has received the response signal from the transmission section 164. Namely, in cases in which the signal generation section 192 determines that the content of the decrypted data expressed by the response signal received by the reception section 191 is correct, the signal generation section 192 generates the authentication-success signal. This authentication-success signal is a signal indicating that the authentication microcomputer 19 has authenticated the relay ECU 16. However, in cases in which the signal generation section 192 determines that the content of the decrypted data expressed by the response signal received by the reception section 191 is erroneous, the signal generation section 192 generates the authentication-fail signal. This authentication-fail signal is a signal indicating that the authentication microcomputer 19 has failed to authenticate the relay ECU 16.

The transmission section 193 transmits the authenticity determination signal generated by the signal generation section 192 to the reception section 161. The transmission section 193 also transmits the authentication-success signal or the authentication-fail signal generated by the signal generation section 192 to a reception section 201 of the control microcomputer 20 through the bus 21.

FIG. 7 is a block diagram illustrating an example of functional configuration of the control microcomputer 20. The control microcomputer 20 includes the reception section 201, a determination section 202, and a transmission section 203 as functional configuration. The reception section 201, the determination section 202, and the transmission section 203 are realized by the CPU 20A of the control microcomputer 20 reading and executing a program stored in the ROM 20B.

The reception section 201 receives the first control request signal and the second control request signal transmitted by the transmission section 164, and also receives the authentication-success signal or the authentication-fail signal transmitted by the transmission section 193. In the present exemplary embodiment, the exchange of the first control request signal between the transmission section 164 and the reception section 201 is implemented as end-to-end (E2E) communication including a data error detection function. Note that in the present specification, E2E communication is an example of “data error detection communication”. Thus, the reception section 201 is able to detect whether or not the content of the first control request signal received from the transmission section 164 is correct content.

The determination section 202 determines whether or not to control the ignition switch 34 that is the control target based on the first control request signal, the second control request signal, and the authentication-success signal or the authentication-fail signal received by the reception section 201. Namely, in cases in which the reception section 201 has received the second control request signal and the authentication-success signal within a predetermined time limit since the reception section 201 received the first control request signal, the determination section 202 decides to control the ignition switch 34. However, in cases in which the reception section 201 has not received the second control request signal or the authentication-success signal within the time limit since the reception section 201 received the first control request signal, the determination section 202 decides not to control the ignition switch 34. The determination section 202 also decides not to control the ignition switch 34 in cases in which the authentication-fail signal has been received. Note that this time limit may for example be 0.5 seconds.

In cases in which the reception section 201 has received the second control request signal and the authentication-success signal within the time limit since the reception section 201 received the first control request signal, the transmission section 203 controls the ignition switch 34. Namely, the transmission section 203 transmits an electrical signal to the ignition switch 34 so as to move the ignition switch 34 from the OFF position to the ON position.

The mobile terminal 40 illustrated in FIG. 1 may for example be a smartphone or a tablet computer. The mobile terminal 40 includes a display section 41 provided with a touch panel. The mobile terminal 40 is configured including a CPU, ROM, RAM, storage, a communication I/F, and an input/output I/F. The CPU, the ROM, the RAM, the storage, the communication I/F, and the input/output I/F are connected so as to be capable of communicating with one another through a bus. The mobile terminal 40 is capable of acquiring date and time-related information from a timer (not illustrated in the drawings). The mobile terminal 40 is capable of wireless communication with the wireless communication device of the autonomous driving kit 14. Moreover, an autonomous driving application (software) is installed in the mobile terminal 40.

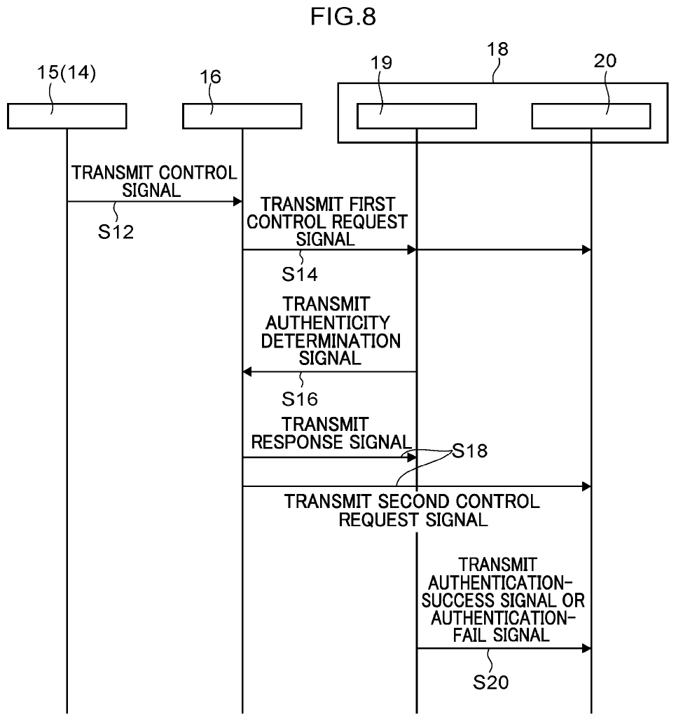

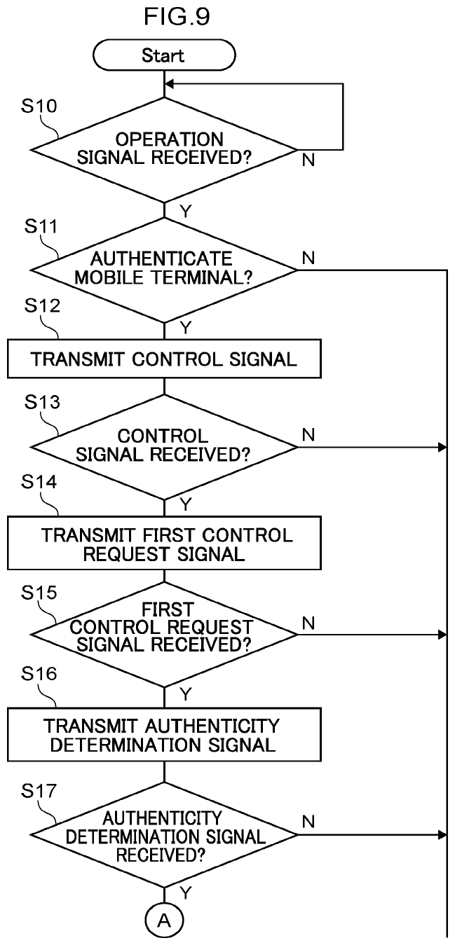

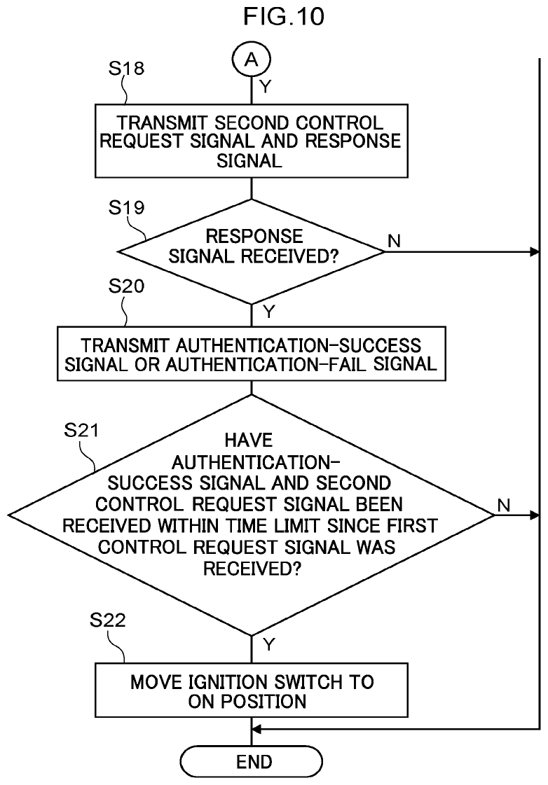

Next, explanation follows regarding a flow of processing performed by the vehicle control device 10 of the present exemplary embodiment, with reference to the sequence chart in FIG. 8 and the flowcharts in FIG. 9 and FIG. 10.

A state is envisaged in which the ignition switch 34 is positioned at the OFF position, power from a regular power source (constant power supply) (not illustrated in the drawings) is supplied to the autonomous driving kit 14, the relay ECU 16, and the verification ECU 18, and the engine is not running. The mobile terminal 40 wirelessly transmits the operation signal in cases in which the hand of an operator (not illustrated in the drawings) touches an activation switch displayed on the display section 41 of the mobile terminal 40 when the autonomous driving application is running while in this state.

At step S10, the ID verification section 151 of the autonomous driving ECU 15 determines whether or not the wireless communication device of the autonomous driving kit 14 has received the operation signal.

In cases in which a determination of YES is made at step S10, at step S11, the ID verification section 151 determines whether or not the ID information for the mobile terminal 40 contained in the operation signal matches the ID information contained in the ID information list recorded in the ROM 15B. Namely, the ID verification section 151 determines whether to authenticate or fail the mobile terminal 40.

In cases in which a determination of YES is made at step S11, at step S12, the signal generation section 152 generates the control signal, and the transmission section 153 transmits the generated control signal to the relay ECU 16.

After the processing of step S12 has ended, at step S13, the reception section 161 of the relay ECU 16 determines whether or not the control signal has been received. When this is performed, the reception section 161 also executes an authentication operation on the autonomous driving ECU 15 (autonomous driving kit 14) using key authentication. In cases in which the reception section 161 authenticates the autonomous driving ECU 15 (autonomous driving kit 14) and has received the control signal, the relay ECU 16 makes a determination of YES at step S13.

In cases in which a determination of YES is made at step S13, at step S14, the control request signal generation section 162 generates the first control request signal, and the transmission section 164 transmits the generated first control request signal to the authentication microcomputer 19 and the control microcomputer 20.

After the processing of step S14 has ended, at step S15, the reception section 191 of the authentication microcomputer 19 and the reception section 201 of the control microcomputer 20 determine whether or not the first control request signal transmitted by the transmission section 164 has been received. When this is performed, the reception section 201 detects whether or not the content of the first control request signal received from the transmission section 164 is correct content using E2E communication. Note that the reception section 201 determines that the reception section 201 has received the first control request signal in cases in which the reception section 201 determines that the content of the received signal is correct. On the other hand, the reception section 201 determines that the reception section 201 has not received the first control request signal in cases in which the reception section 201 determines that the content of the received signal is erroneous. In cases in which the reception section 191 and the reception section 201 determine that the first control request signal has been received, a determination of YES is made at step S15. Namely, in cases in which the reception section 191 or the reception section 201 determine that the first control request signal has not been received, a determination of NO is made at step S15.

In cases in which a determination of YES is made at step S15, at step S16, the signal generation section 192 generates the authenticity determination signal, and the transmission section 193 transmits the generated authenticity determination signal to the relay ECU 16. Namely, the authentication microcomputer 19 (transmission section 193) receiving the first control request signal from the relay ECU 16 (transmission section 164) acts as a trigger for the authentication microcomputer 19 to start the authentication operation.

After the processing of step S16 has ended, at step S17, the reception section 161 of the relay ECU 16 determines whether or not the reception section 161 has received the authenticity determination signal.

In cases in which a determination of YES is made at step S17, at step S18, the control request signal generation section 162 generates the second control request signal and the response signal generation section 163 generates the response signal. Also at step S18, the transmission section 164 transmits the generated second control request signal to the control microcomputer 20, and transmits the generated response signal to the authentication microcomputer 19.

After the processing of step S18 has ended, at step S19, the reception section 191 of the authentication microcomputer 19 determines whether or not the reception section 191 has received the response signal.

In cases in which a determination of YES is made at step S19, at step S20, the signal generation section 192 generates the authentication-success signal or the authentication-fail signal, and the transmission section 193 transmits the generated authentication-success signal or authentication-fail signal to the reception section 201 of the control microcomputer 20 through the bus 21.

After the processing of step S20 has ended, at step S21, the determination section 202 of the control microcomputer 20 determines whether or not the reception section 201 has received the authentication-success signal and the second control request signal within the time limit since the reception section 201 received the first control request signal at step S15.

In cases in which a determination of YES is made at step S21, at step S22, the transmission section 203 moves the ignition switch 34 from the OFF position to the ON position. Thus, power from the power source 38 is supplied to the engine ECU 30 through the feed line 36 so as to begin control of the engine. In this manner, the control microcomputer 20 (determination section 202) determines whether the relay ECU 16 has been authenticated or has failed authentication based on the type of received signal, and controls the ignition switch 34 in cases in which the relay ECU 16 has been authenticated.

After the processing of step S22 has ended or a determination of NO is made at step S11, S13, S15, S17, S19, or S21, the vehicle control device 10 ends the current round of the processing in the flowcharts of FIG. 9 and FIG. 10.

### Operation and Advantageous Effects

Next, explanation follows regarding operation and advantageous effects of the present exemplary embodiment.

As described above, in the vehicle control device 10 of the present exemplary embodiment, in cases in which the authentication microcomputer 19 has authenticated the relay ECU 16, the control microcomputer 20 controls the ignition switch 34 provided to the vehicle 12 based on the control request signals (first control request signal and second control request signal) received from the relay ECU 16. The authentication microcomputer 19 uses AES to determine whether or not the relay ECU 16 is being managed by a person (a party) with malicious intent. Namely, the authentication microcomputer 19 prevents “impersonation” by a person with malicious intent. This enables the ignition switch 34 to be controlled based on the control request signals received by the control microcomputer 20, while ensuring the trustworthiness of the relay ECU 16 transmitting the control request signals to the control microcomputer 20, in cases in which the vehicle control device 10 (autonomous driving kit 14) has received the operation signal from the mobile terminal 40.

Furthermore, the exchange of the first control request signal between the transmission section 164 and the reception section 201 is implemented as E2E communication. Namely, the reception section 201 detects whether or not the content of the first control request signal received from the transmission section 164 is the correct content. In this manner, the vehicle control device 10 of the present exemplary embodiment detects whether or not an error is present in the data received by the reception section 201, and the authentication microcomputer 19 prevents “impersonation”, such that a high level of security is attained.

Furthermore, the control microcomputer 20 controls the ignition switch 34 in cases in which the control microcomputer 20 has received the second control request signal in addition to the first control request signal. The first control request signal and the second control request signal are signals that are generated and transmitted by the relay ECU 16. Thus, the determination regarding the trustworthiness of the relay ECU 16 made by the verification ECU 18 is more accurate than if the control microcomputer 20 were to control the ignition switch 34 based only on the first control request signal and the authentication-success signal.

Thus, for example, in cases in which the vehicle 12 is employed in a car-sharing system, an unauthorized person is effectively prevented from driving and operating the vehicle 12 by operating the mobile terminal 40.

Furthermore, the control microcomputer 20 controls the ignition switch 34 in cases in which the control microcomputer 20 have received the authentication-success signal and the second control request signal within the predetermined time limit since the control microcomputer 20 received the first control request signal. If there were no limit on the duration from the control microcomputer 20 receiving the first control request signal to receiving the authentication-success signal and the second control request signal, there would be an increased risk of a person with malicious intent operating an untrustworthy relay ECU 16 and thereby causing the relay ECU 16 to transmit the response signal and the second control request signal so as to cause the authentication microcomputer 19 to transmit the authentication-success signal. However, in cases in which the duration from the control microcomputer 20 receiving the first control request signal to the control microcomputer 20 receiving the authentication-success signal and the second control request signal is limited to the predetermined time limit as in the present exemplary embodiment, there is a low risk of such an issue arising.

Furthermore, in cases in which E2E communication and AES are employed, there is no need to provide the vehicle control device 10 with a specialist device. For example, if the authentication microcomputer 19 used a MAC key to determine whether to authenticate or fail the relay ECU 16, the vehicle control device 10 would need an additional specialist device for executing authentication using the MAC key. However, in the present exemplary embodiment, the vehicle control device 10 does not need to be provided with such a specialist device.

Although the vehicle control device 10, the vehicle 12, the vehicle control method, and the non-transitory recording medium according to the present exemplary embodiment have been described above, design of the vehicle control device 10, the vehicle 12, the vehicle control method, and the non-transitory recording medium may be modified as appropriate within a range not departing from the spirit of the present disclosure.

For example, the transmission section 203 may move the ignition switch 34 from the ON position to the OFF position at step S22. Alternatively at step S22, the ignition switch 34 may be moved to the ON position in cases in which the ignition switch 34 is positioned at the OFF position, and the ignition switch 34 may be moved to the OFF position in cases in which the ignition switch 34 is positioned at the ON position.

The control target controlled by the control microcomputer 20 is not necessarily the ignition switch 34. For example, the control microcomputer 20 may control an actuator of a door locking device of the vehicle 12 serving as its control target.

Moreover, configuration may be such that the authentication microcomputer 19 transmits the authentication-success signal to the control microcomputer 20 in cases in which the authentication microcomputer 19 has authenticated the relay ECU 16, and refrains from transmitting a signal to the control microcomputer 20 in cases in which the authentication microcomputer 19 has failed to authenticate the relay ECU 16.

Instead of E2E communication, a cyclic redundancy check (CRC) may be used as “data error detection communication” to carry out the exchange of the first control request signal between the transmission section 164 and the reception section 201.

Configuration may be such that the authentication microcomputer 19 authenticates the relay ECU 16 using a different authenticity determination signal to AES. For example, an authenticity determination signal expressing a random number, a public key, or a common key may be employed. Alternatively, an authenticity determination signal expressing a MAC key may be employed.

Moreover, configuration may be such that the control microcomputer 20 controls the control target in cases in which the first control request signal and the authentication-success signal have been received, without the relay ECU 16 transmitting the second control request signal to the verification ECU 18.

Moreover, configuration may be such that the relay ECU 16 only transmits the first control request signal to the authentication microcomputer 19 and not to the control microcomputer 20. In such cases, the control microcomputer 20 controls the control target in cases in which the control microcomputer 20 has received the second control request signal and the authentication-success signal.

The time limit may be a time period other than 0.5 seconds. However, the time limit is preferably a short time period.

Alternatively, configuration may be such that the time limit is not provided.

A computer server that is capable of wireless communication with the vehicle 12 may be employed as external communication equipment. For example, the computer server (external communication equipment) of a car-sharing company may transmit the operation signal to the vehicle 12 (autonomous driving kit 14) in cases in which a customer of the car-sharing company has accessed the computer server through the mobile terminal 40.

Configuration may be such that the autonomous driving kit (communication section) 14 receives the operation signal transmitted by an operating device provided to the vehicle 12. Such an operating device may for example be included in a display (touch panel) provided to an instrument panel.

The present disclosure may be applied to a vehicle 12 that does not include an autonomous driving function.

Moreover, a different device to the autonomous driving kit 14 may be employed as the “communication section”. For example, an autonomous parking control device (not illustrated in the drawings) including an ECU may be provided to the vehicle 12 as the “communication section” for communicating with the relay ECU 16. In such cases, on the receiving the operation signal from the mobile terminal 40, the autonomous parking control device transmits the control signal to the relay ECU 16, and the control microcomputer 20 controls the steering wheel and so on to execute autonomous parking control.

The manufacturer that manufactured the communication section may be the same manufacturer as the manufacturer that manufactured the vehicle 12.

What is claimed is:

1. A vehicle control device including a processor installed at a vehicle, wherein:
the processor is electrically connected to a communication section that transmits a control signal upon receiving an operation signal and to a relay section that transmits a control request signal upon receiving the control signal; and
the processor includes a first processor and a second processor,
the first processor being configured to execute an authentication operation to authenticate or not authenticate the relay section, in a case in which the relay section has received the control signal, and
the second processor being configured to control a control target provided at the vehicle based on the control request signal received from the relay section, in a case in which an authentication-success signal indicating that the relay section is authentic has been received from the first processor.

2. The vehicle control device of claim 1, wherein the first processor is configured to:
transmit an authenticity determination signal for determining whether to authenticate or not authenticate the relay section to the relay section, in a case in which the first processor has received a first control request signal serving as the control request signal from the relay section; and
transmit the authentication-success signal to the second processor, in a case in which the first processor has determined that the relay section is authentic.

3. The vehicle control device of claim 2, wherein, in a case in which the relay section has transmitted a response signal to the first processor in response to the authenticity determination signal, the first processor transmits the authentication-success signal or an authentication-fail signal indicating that the relay section failed authentication, to the second processor based on a type of the received response signal.

4. The vehicle control device of claim 3, wherein:
in a case in which the relay section has received the authenticity determination signal, the relay section transmits the response signal to the first processor and transmits a second control request signal serving as the control request signal to the second processor; and
the second processor controls the control target, in a case in which the second processor has received the first control request signal, the authentication-success signal, and the second control request signal.

5. The vehicle control device of claim 4, wherein the second processor controls the control target, in a case in which the second processor has received the authentication-success signal and the second control request signal within a predetermined time limit since the second processor received the first control request signal.

6. The vehicle control device of claim 1, wherein:
the control target is a power source configured to supply power to a drive source of the vehicle so as to operate the drive source; and
the second processor switches the power source from one state to another state of a power supply-disabled state or a power supply-enabled state, in a case in which the second processor has received the control request signal.

7. A vehicle comprising the vehicle control device of claim 1, the vehicle control device including the communication section, the relay section, and the processor.

8. The vehicle of claim 7, wherein the communication section transmits the control signal in a case in which the communication section has received the operation signal from external communication equipment.

9. A vehicle control method comprising:
a communication section installed at a vehicle transmitting a control signal upon receiving an operation signal;
a relay section installed at the vehicle transmitting a control request signal upon receiving the control signal from the communication section;
a first processor installed at the vehicle executing an authentication operation to authenticate or not authenticate the relay section, in a case in which the relay section has received the control signal; and
a second processor installed at the vehicle controlling a control target provided at the vehicle based on the control request signal received from the relay section, in a case in which an authentication-success signal indicating that the relay section is authentic has been received from the first processor.

10. A non-transitory recording medium storing a program executable by a computer to perform processing, the processing comprising:
a communication section installed at a vehicle transmitting a control signal upon receiving an operation signal;
a relay section installed at the vehicle transmitting a control request signal upon receiving the control signal from the communication section;
executing an authentication operation to authenticate or not authenticate the relay section, in a case in which the relay section has received the control signal; and
controlling a control target provided at the vehicle based on the control request signal received from the relay section, in a case in which an authentication-success signal indicating that the relay section is authentic has been received.
